(19) United States
(12) Patent Application Publication
(10) Pub. No.: US 2026/0006620 A1
(43) Pub. Date: Jan. 1, 2026

(54) METHODS AND APPARATUSES FOR CBGTI INDICATION IN DCI SCHEDULING MULTIPLE PHYSICAL DATA CHANNELS

(71) Applicant: LENOVO (BEIJING) LIMITED, Beijing (CN)

(72) Inventors: Haipeng Lei, Beijing (CN); Yu Zhang, Beijing (CN); Ruixiang Ma, Beijing (CN); Haiming Wang, Beijing (CN)

(21) Appl. No.: 18/992,120

(22) PCT Filed: Jul. 8, 2022
(86) PCT No.: PCT/CN2022/104600

§ 371 Date: Jan. 7, 2025

(51) Int. Cl. H04W 72/231; H04L 1/1607; H04L 1/1812; H04L 5/00; H04W 72/12

(52) U.S. Cl. CPC H04W 72/231; H04L 1/1614; H04L 1/1812; H04L 5/0053; H04W 72/12

(57) ABSTRACT

Embodiments of the present disclosure relate to methods and apparatuses for code block group (CBG) transmission information (CBGTI) indication in downlink control channel (DCI) scheduling multiple physical data channels. According to some embodiments of the disclosure, a UE may include: a processor; and a transceiver coupled to the transceiver and configured to: receive DCI scheduling a first set of transport blocks (TBs) in a transmission, wherein the DCI includes a field indicating CBG-level transmission information for a second set of TBs, wherein the second set of TBs is a subset of the first set of TBs and scheduled by the DCI for retransmission in the transmission; and receive a CBG(s) of each TB of the second set of TBs based on the field in response to the transmission being scheduled for downlink (DL) transmission; or transmit a CBG(s) of each TB of the second set of TBs based on the field in response to the transmission being scheduled for uplink (UL) transmission.

### TECHNICAL FIELD

Embodiments of the present disclosure generally relate to wireless communication technology, and more particularly to methods and apparatuses for code block group (CBG) transmission information (CBGTI) indication in downlink control channel (DCI) scheduling multiple physical data channels, e.g., physical downlink shared channels (PDSCHs) or physical uplink shared channels (PUSCHs).

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, some kinds of traffic, e.g., extended reality (XR) traffic, may have a variable data packet size and stringent transmission latency. For such kinds of traffic, using one DCI scheduling multiple PDSCHs or PUSCHs can greatly save DCI overhead, reduce scheduling latency and power consumption for PDCCH monitoring of a user equipment (UE). In addition, besides TB-based (re)transmission, a CBG-based (re)transmission is also supported in a wireless communication system.

There is a need for combining the multi-PDSCH or multi-PUSCH scheduling by a single DCI with the CBG-based (re)transmission.

### SUMMARY

Some embodiments of the present disclosure provide a UE. The UE may include: a processor; and a transceiver coupled to the transceiver and configured to: receive downlink control information (DCI) scheduling a first set of transport blocks (TBs) in a transmission, wherein the DCI includes a field indicating CBG-level transmission information for a second set of TBs, wherein the second set of TBs is a subset of the first set of TBs and scheduled by the DCI for retransmission in the transmission; and receive a CBG(s) of each TB of the second set of TBs based on the field in response to the transmission being scheduled for downlink (DL) transmission; or transmit a CBG(s) of each TB of the second set of TBs based on the field in response to the transmission being scheduled for uplink (UL) transmission.

Some embodiments of the present disclosure provide a base station (BS). The BS may include: a processor; and a transceiver coupled to the transceiver and configured to: transmit DCI scheduling a first set of TBs in a transmission, wherein the DCI includes a field indicating CBG-level transmission information for a second set of TBs, wherein the second set of TBs is a subset of the first set of TBs and scheduled by the DCI for retransmission in the transmission; and transmit a CBG(s) of each TB of the second set of TBs based on the field in response to the transmission being scheduled for DL transmission; or receive a CBG(s) of each TB of the second set of TBs based on the field in response to the transmission being scheduled for UL transmission.

Some embodiments of the present disclosure provide a method performed by a UE. The method may include: receiving DCI scheduling a first set of TBs in a transmission, wherein the DCI includes a field indicating CBG-level transmission information for a second set of TBs, wherein the second set of TBs is a subset of the first set of TBs and scheduled by the DCI for retransmission in the transmission; and receiving a CBG(s) of each TB of the second set of TBs based on the field in response to the transmission being scheduled for DL transmission; or transmitting a CBG(s) of each TB of the second set of TBs based on the field in response to the transmission being scheduled for UL transmission.

Some other embodiments of the present disclosure provide a method performed by a BS. The method may include: transmitting DCI scheduling a first set of TBs in a transmission, wherein the DCI includes a field indicating CBG-level transmission information for a second set of TBs, wherein the second set of TBs is a subset of the first set of TBs and scheduled by the DCI for retransmission in the transmission; and transmitting a CBG(s) of each TB of the second set of TBs based on the field in response to the transmission being scheduled for DL transmission; or receiving a CBG(s) of each TB of the second set of TBs based on the field in response to the transmission being scheduled for UL transmission.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2 and 3 illustrate schematic diagrams of DCI scheduling a transmission in accordance with some embodiments of the present disclosure;

FIG. 4 illustrates exemplary NDIs and bitmap in accordance with some embodiments of the present disclosure;

FIG. 5 illustrates exemplary NDIs and indicator in accordance with some embodiments of the present disclosure;

FIGS. 6-8 illustrate exemplary NDIs and bitmap in accordance with some embodiments of the present disclosure;

FIGS. 9 and 10 illustrate flow charts of exemplary methods for CBGTI indication in a DCI according to some embodiments of the present disclosure; and

FIG. 11 illustrates a simplified block diagram of an exemplary apparatus for CBGTI indication in DCI according to some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

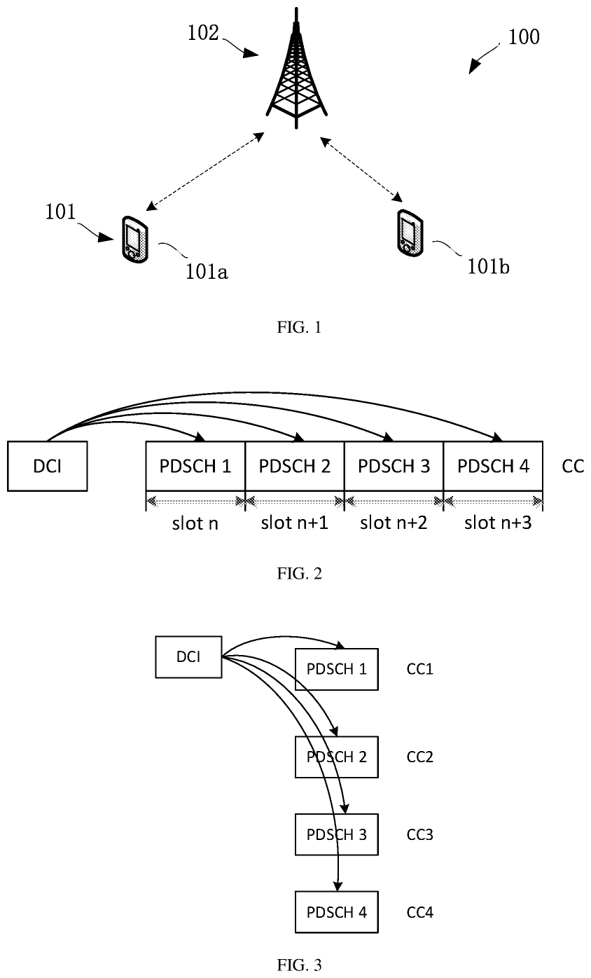

FIG. 1 illustrates a schematic diagram of a wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via UL communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via DL communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In a wireless communication system, some kinds of traffic, e.g., extended reality (XR) traffic, may have a variable data packet size and stringent transmission latency. Sometimes, such kinds of traffic may have a larger data packet size and require several slots to complete the transmission. Using one DCI scheduling multiple PDSCHs or PUSCHs can greatly save DCI overhead, reduce scheduling latency and UE power consumption for PDCCH monitoring. Accordingly, it is desirable to schedule multiple PDSCHs or PUSCHs in multiple slots on the same cell by a DCI or schedule multiple PDSCHs or PUSCHs on multiple cells by a DCI.

In NR, besides TB-based (re)transmission, CBG-based (re)transmission is also supported. For the TB-based (re)transmission, one HARQ-ACK feedback bit, namely a TB-based HARQ-ACK feedback or a TB-level HARQ-ACK feedback, may correspond to one TB and be used to indicate whether the TB is correctly decoded by the UE or not. For the CBG-based (re)transmission, one HARQ-ACK feedback bit, namely a CBG-based HARQ-ACK feedback or a CBG-level HARQ-ACK feedback, may correspond to one CBG of a TB and be used to indicate whether the CBG is correctly decoded by the UE or not.

For the CBG-based (re)transmission, a UE may receive a radio resource control (RRC) signaling from a BS. The RRC signaling may configure a maximum number of CBGs per TB. For example, the maximum number of CBGs per TB may be 2, 4, 6 and 8. For both semi-static HARQ-ACK codebook and dynamic HARQ-ACK codebook, the number of HARQ-ACK bits for one TB may be equal to the configured maximum number of CBGs per TB, regardless of the variable TB size of a given TB.

Given the above, when combining the multi-PDSCH or multi-PUSCH scheduling by a single DCI with the CBG-based retransmission, the problem is that the CBGTI indication in the scheduling DCI may require a huge signaling overhead. For example, assuming that RRC signaling configures that a maximum number of CBGs per TB is 8 and a maximum number of TBs schedulable by a DCI is 8. Then, an CBGTI indication in a DCI may need 8*8=64 bits, wherein each bit is associated with a corresponding CBG of a corresponding TB and indicates whether the corresponding CBG is retransmitted or not. Accordingly, to exploit the benefit of CBG-based transmission and multi-PDSCH or multi-PUSCH scheduling by a single DCI, how to reduce the signaling overhead on CBGTI indication in a DCI needs to be addressed.

Given the above, embodiments of the present disclosure propose solutions for CBGTI indication in DCI scheduling multiple physical data channels, which can at least solve the above technical problems. For example, embodiments of the present disclosure provide several solutions for indicating transmission information of CBGs of scheduled TBs in a DCI when CBG-based transmission and multi-PDSCH or multi-PUSCH scheduling by a single DCI are both configured to the UE. Embodiments of the present disclosure can reduce the signaling overhead to a relatively reasonable level. More details on the embodiments of the present disclosure will be illustrated in the following text in combination with the appended drawings.

### Embodiment 1

In Embodiment 1, a BS (e.g., BS 102 as shown in FIG. 1) may transmit, to a UE (e.g., UE 101 as shown in FIG. 1), a DCI scheduling a first set of TBs on a set of PDSCHs in a DL transmission. The first set of TBs may include one or more TBs, where each TB of the first set of TBs may be scheduled on a corresponding PDSCH of the set of PDSCHs. In some embodiments of the present disclosure, the first set of TBs on the set of PDSCHs may be scheduled on different serving cells of the UE or in different slots on the same serving cell of the UE. In some embodiments, the cells (or carriers) on which the PDSCHs are scheduled may or may not include the cell (or carrier) on which the DCI is transmitted.

The UE may receive, from the BS, the DCI scheduling the first set of TBs on the set of PDSCHs in a DL transmission.

The DCI may include a field indicating CBG-level transmission information.

In some embodiments of the present disclosure, the BS may transmit RRC signaling indicating whether the field is included in a DCI or not. The UE may determine whether the field is included in a DCI based on the RRC signaling. In some embodiments of the present disclosure, the field is included in a DCI in the case that a CBG-based transmission is configured for the UE and the DCI schedules a plurality of physical data channels (e.g., PDSCHs or PUSCHs) or a plurality of TBs (e.g., the first set of TBs includes a plurality of TBs).

The size of the field may be based on (e.g., equal to or greater than) the maximum number of TBs schedulable by the DCI. In some embodiments of the present disclosure, the maximum number of TBs schedulable by the DCI may be configured by RRC signaling from the BS. In some embodiments of the present disclosure, the maximum number of TBs schedulable by the DCI may be implicitly determined. For example, it may be determined based on at least one of: the maximum number of start and length indicator values (SLIVs) in an entry of a time domain resource allocation (TDRA) table; the maximum number of schedulable cells by the DCI; or the maximum number of codewords per a PDSCH. Since the UE can determine the size of the field, the UE can determine the DCI payload size of the DCI.

In some embodiments of the present disclosure, the field may indicate CBG-level transmission information for the first set of TBs. For example, the field may include a bitmap. The size of the bitmap may be based on (e.g., equal to or greater than) the maximum number of TBs schedulable by the DCI. Each bit in the bitmap may correspond to a TB of the first set of TBs and indicates whether all CBGs or only a subset of CBGs of the TB are transmitted in the transmission. The first set of TBs may include initially transmitted TBs and retransmitted TBs. A second set of TBs may be a subset of the first set of TBs and are scheduled by the DCI for retransmission in the transmission. That is, the second set of TBs are retransmitted TBs.

In some embodiments of the present disclosure, the field may indicate CBG-level transmission information for the retransmitted TBs (e.g., the second set of TBs). For example, the field may include a bitmap. The size of the bitmap may be based on (e.g., equal to or greater than) the maximum number of TBs schedulable by the DCI. Each bit in the bitmap corresponds to a TB of the second set of TBs and indicates whether all CBGs or only a subset of CBGs of the TB are transmitted in the transmission.

A subset of CBGs of a TB in the above embodiments may refer to failed CBGs of the TB, which includes a CBG(s) which is not correctly decoded in a previous transmission of the TB or a CBG(s) that is responded with a NACK in the CBG-based HARQ-ACK feedback.

For a TB, when a bit in the bitmap indicates that all CBGs of the TB are transmitted in the transmission, it implies that the entire TB is transmitted in the transmission; when a bit in the bitmap indicates that a subset of CBGs of the TB are transmitted in the transmission, it implies that the subset of CBGs (e.g., failed CBGs) are retransmitted in the transmission.

For example, for a TB, the corresponding bit “1” in the bitmap may indicate that only the subset of CBGs of the TB is transmitted in the transmission; the corresponding bit “0” in the bitmap may indicate that all CBGs of the TB are transmitted in the transmission; or vice versa.

The following descriptions illustrate the operation of the BS side.

According to some embodiments of the present disclosure, before the current transmission, the BS may receive CBG-based HARQ-ACK feedback for one or more TBs in a previous transmission.

In some examples, for a TB of the one or more TBs, the corresponding CBG-based HARQ-ACK feedback may indicate a NACK(s) for a subset of CBGs of the TB. That is, the CBG-based HARQ-ACK feedback for this TB (denoted as TB #1 for clarity) indicates that the subset of CBGs of TB #1 is not correctly decoded at the UE and may need to be retransmitted. The BS may determine to retransmit TB #1 (e.g., the entire TB #1 or the subset of CBGs (e.g., failed CBG(s)) of TB #1). In such cases, the second set of TBs scheduled by the DCI for retransmission may include TB #1. The BS may correspondingly set a bit in the bitmap corresponding to TB #1. For example, in the case that the BS determines to retransmit the entire TB #1, the corresponding bit may be set to indicate all CBGs of the TB are transmitted. In the case that the BS determines to retransmit the failed CBG(s) of TB #1, the corresponding bit may be set to indicate a subset of CBGs of the TB is transmitted.

In some examples, for each CBG of the one or more TBs, the corresponding CBG-based HARQ-ACK feedback may indicate an ACK. That is, all of the one or more TBs are correctly decoded at the UE. In such cases, the first set of TBs may not include any retransmitted TB, but only includes initially transmitted TB.

Whether a TB scheduled by a DCI is initially transmitted or retransmitted can be determined based on a corresponding NDI in the DCI. For example, according to some embodiments of the present disclosure, for an initially transmitted TB in the first set of TBs, the BS may set an NDI corresponding to the TB to indicate that the TB is initially transmitted. The BS may also set a bit in the bitmap in the field corresponding to the TB to indicate that all CBGs of the TB are transmitted in the transmission.

According to some embodiments of the present disclosure, for a retransmitted TB in the first set of TBs, the BS may set an NDI corresponding to the TB to indicate that the TB is retransmitted. In the case that the BS determines to retransmit the entire TB, the BS may set a bit in the bitmap in the field corresponding to the TB to indicate that all CBGs of the TB are transmitted in the transmission. In the case that the BS determines to only retransmit a subset of CBGs which are not correctly decoded in the previous transmission or responded with NACKs in the CBG-based HARQ-ACK feedback, the BS may set a bit in the bitmap in the field corresponding to the TB to indicate that only a subset of CBGs of the TB are transmitted.

According to some embodiments of the present disclosure, for a TB of the first set of TBs, the BS may set a bit of the bitmap corresponding to the TB to indicate all CBGs of the TB are transmitted in the transmission in response to at least one of the following:
the transmission is an initial transmission of the TB;
a plurality of CBGs (e.g., majority) of the TB need to be retransmitted, for example, indicated as not correctly decoded in a previous transmission or responded with NACK in the corresponding CBG-based HARQ-ACK feedback;
the TB has a small size;
the TB is scheduled by a fallback DCI format (e.g., DCI format 1_0) in a previous transmission;
the TB is transmitted without associated scheduling DCI in a previous transmission, e.g., the TB is scheduled on a semi-persistent scheduling (SPS) PDSCH; or
none of CBGs of the TB is correctly decoded in a previous transmission or all CBGs of the TB are responded with NACK in the corresponding CBG-based HARQ-ACK feedback.

The following descriptions illustrate the operation from the UE side.

In response to receiving the DCI scheduling the first set of TBs, the UE may check NDIs corresponding to the first set of TBs. For example, for a TB in the first set of TBs, the UE may check an NDI corresponding to the TB.

In the case that the NDI indicates that the TB is initially transmitted, in an example, the UE may ignore the bit corresponding to the TB in the field in the DCI; in another example, the UE may check the bit corresponding to the TB in the field and assume that the bit indicates that all CBGs of the TB are transmitted in the transmission. In such case, the UE does not expect that the bit is set to a value indicating only a subset of CBGs of the TB is transmitted in the transmission when the NDI indicates that the TB is initially transmitted.

In the case that the NDI indicates that the TB is retransmitted, the UE may check the bit corresponding to the TB in the field in the DCI and determine whether all CBGs of the TB are transmitted in the transmission or only a subset of CBGs (e.g., failed CBGs) of the TB is transmitted in the transmission based on the corresponding bit in the field.

In such case, when all CBGs of the TB are transmitted in the transmission, the UE may combine all CBGs of the TB received in the transmission with all CBGs of the TB received in a previous transmission for decoding the TB. When only the subset of CBGs of the TB is transmitted in the transmission, the UE may combine the subset of CBGs of the TB received in the transmission with CBG(s) of the TB received in a previous transmission and having the same CBG index(es) as those of the subset of CBGs for further decoding.

It is assumed that TB1 and TB2 are not correctly decoded in a previous transmission, wherein CBG1 and CBG2 of TB1 and CBG2 and CBG3 of TB2 are incorrectly decoded while CBG0 and CBG3 of TB1 and CBG0 and CBG1 of TB2 are correctly decoded. It is assumed that the maximum number of TBs schedulable by a DCI is 4 and the maximum number of CBGs per a TB is 4. Consequently, the CBG-based HARQ-ACK feedback for TB1 which is transmitted by the UE and received by the BS may be {A, N. N, A} and the CBG-based feedback for TB2 which is transmitted by the UE and received by the BS may be {A, A, N. N}, wherein “A” denotes an ACK and “N” denotes a NACK.

After receiving the CBG-based HARQ-ACK feedback for TB1 and TB2, the BS may determine to schedule the retransmissions of both TB1 and TB2 and initial transmissions of TB3 and TB4 by a DCI.

In some embodiments, TB1 is carried by PDSCH 1, TB2 is carried by PDSCH 2, TB3 is carried by PDSCH 3, and TB4 is carried by PDSCH 4.

In an example, the four PDSCHs are scheduled in different slots on the same serving cell (e.g., on the same component carrier (CC)) of the UE as shown in FIG. 2. For example, referring to FIG. 2, PDSCH 1, PDSCH 2, PDSCH 3, and PDSCH 4 are scheduled in slot n, slot n+1, slot n+2, and slot n+3 of the same CC, respectively.

In another example, the four PDSCHs are scheduled in different serving cells (e.g., on different CCs) of the UE as shown in FIG. 3. For example, referring to FIG. 3, PDSCH 1, PDSCH 2, PDSCH 3, and PDSCH 4 are scheduled on CC1 to CC4, respectively. It should be noted that although each of PDSCH 1, PDSCH 2, PDSCH 3, and PDSCH 4 is shown as scheduled on a different CC in FIG. 3, two or more of the PDSCHs may be scheduled on the same CCs in some other embodiments of the present disclosure.

The DCI may include 4 NDIs, e.g., “a0, al, a2, a3,” corresponding to TB1-TB4, respectively. In some examples, a0 corresponds to TB1 and indicates that TB1 is retransmitted, al corresponds to TB2 and indicates that TB2 is retransmitted, a2 corresponds to TB3 and indicates that TB3 is initially transmitted, a3 corresponds to TB4 and indicates that TB4 is initially transmitted.

The DCI may include a field indicating CBG-level transmission information for TB1, TB2, TB3, and TB4. For example, the field may include a bitmap “b0, b1, b2, b3,” wherein b0 corresponds to TB1 and indicates that a subset of CBGs (e.g., failed CBGs) of TB1 is transmitted in the transmission, bl corresponds to TB2 and indicates that a subset of CBGs (e.g., failed CBGs) of TB2 is transmitted in the transmission, b2 corresponds to TB3 and indicates that all CBGs of TB3 is transmitted in the transmission, and b3 corresponds to TB4 and indicates that all CBGs of TB4 is transmitted in the transmission.

In response to receiving the DCI scheduling TB1 to TB4, for each TB, the UE may check an NDI corresponding to the TB. For example, for TB3, the UE may check “a2” in the DCI, and since “a2” indicates that TB3 is initially transmitted, the UE may ignore “b2” or may check “b2”. Similarly, for TB4, the UE may check “a3” in the DCI, and since “a3” indicates that TB4 is initially transmitted, the UE may ignore “b3” or may check “b3”.

For TB1, since the NDI “a0” indicates that TB1 is retransmitted, the UE may check “b0” in the bitmap, and determines that CBG1 and CBG2 of TB1 are retransmitted based on the value of “b0” indicating only failed CBGs are transmitted and the previous HARQ-ACK feedback for TB1. Then, the UE may combine CBG1 and CBG2 of TB1 received in the transmission with CBGs with the same indexes as CBG1 and CBG2 received in the previous transmission for further decoding.

Similarly, for TB2, since the NDI “a1” indicates that TB2 is retransmitted, the UE may check “b1” in the bitmap, and determines that CBG2 and CBG3 of TB2 are retransmitted based on the value of “b1” indicating only failed CBGs are transmitted and the previous HARQ-ACK feedback for TB2. Then, the UE may combine CBG2 and CBG3 of TB2 received in the transmission with CBGs with the same indexes as CBG2 and CBG3 received in the previous transmission for further decoding.

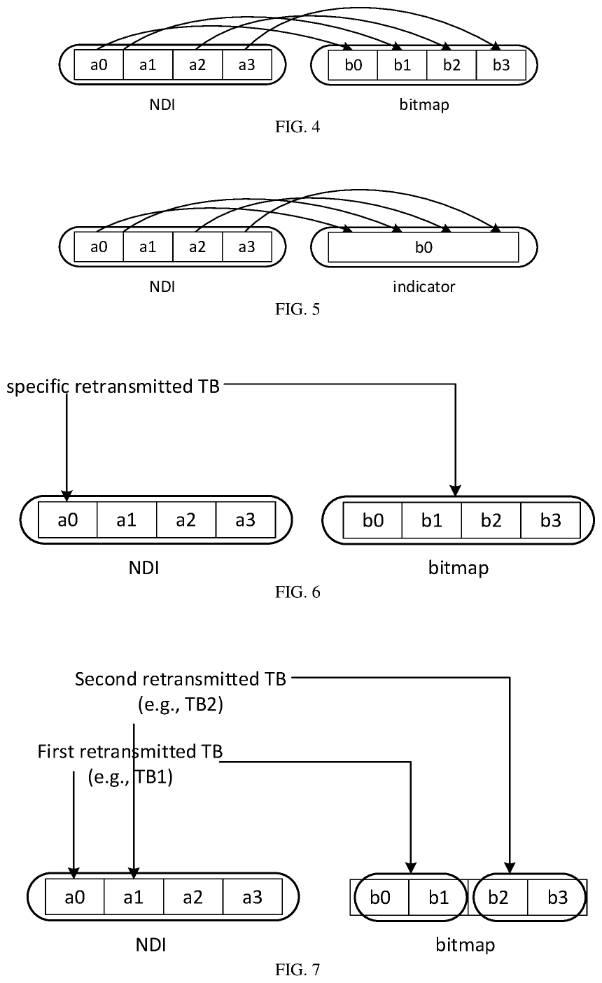

FIG. 4 illustrates exemplary NDIs and a bitmap in accordance with some embodiments of the present disclosure. Referring to FIG. 4, each NDI “a0,” “a1”, “a2,” or “a3” may correspond to a bit “b0,” “b1”, “b2,” or “b3” in the bitmap, respectively. For example, the UE may first check an NDI corresponding to a TB and then check a bit corresponding to the TB.

### Embodiment 2

In Embodiment 2, a BS (e.g., BS 102 as shown in FIG. 1) may transmit, to a UE (e.g., UE 101 as shown in FIG. 1), a DCI scheduling a first set of TBs on a set of PDSCHs in a DL transmission. The first set of TBs may include one or more TBs, where each TB of the first set of TBs may be scheduled on a corresponding PDSCH of the set of PDSCHs. In some embodiments of the present disclosure, the first set of TBs on the set of PDSCHs may be scheduled on different serving cells of the UE or in different slots on the same serving cell of the UE. In some embodiments, the cells (or carriers) on which the PDSCHs are scheduled may or may not include the cell (or carrier) on which the DCI is transmitted.

The UE may receive, from the BS, the DCI scheduling the first set of TBs on the set of PDSCHs in a DL transmission.

The DCI may include a field indicating CBG-level transmission information.

In some embodiments of the present disclosure, the BS may transmit RRC signaling indicating whether the field is included in a DCI or not. The UE may determine whether the field is included in the DCI based on the RRC signaling. In some embodiments of the present disclosure, the field is included in a DCI in the case that a CBG-based transmission is configured for the UE and the DCI schedules a plurality of physical data channels (e.g., PDSCHs or PUSCHs) or a plurality of TBs (e.g., the first set of TBs includes a plurality of TBs).

In some embodiments, the first set of TB may include a second set of TBs, wherein the second set of TBs may be a subset of the first set of TBs and are scheduled by the DCI for retransmission in the transmission. That is, the second set of TBs are retransmitted TBs. In some embodiments, the field in the DCI may include an indicator indicating whether all CBGs or only a subset of CBGs of each TB of the second set of TBs are transmitted.

A subset of CBGs of a TB in the above embodiments may refer to failed CBGs of the TB, which include a CBG(s) which is not correctly decoded in a previous transmission of the TB or a CBG(s) which is responded with a NACK in a CBG-based HARQ-ACK feedback.

When the indicator indicates that all CBGs of each TB of the second set of TBs are transmitted, it implies that all CBGs of each TB of the second set of TBs are retransmitted in the transmission, i.e., the entire TB of each TB of the second set of TBs is retransmitted in the transmission. When the indicator indicates that only a subset of CBGs of each TB of the second set of TBs is transmitted, it implies that only the corresponding subset of CBGs (e.g., failed CBGs) of each TB of the second set of TBs is retransmitted in the transmission.

For example, the indicator may be a 1-bit indicator corresponding to all of the second set of TBs. The bit value “1” may indicate that only the subset of CBGs of each TB of the second set of TBs is retransmitted in the transmission; and the bit value “0” may indicate that all CBGs of each TB of the second set of TBs are retransmitted in the transmission; or vice versa.

The following descriptions illustrate the operation of the BS side.

According to some embodiments of the present disclosure, before the current transmission, the BS may receive CBG-based HARQ-ACK feedback for one or more TBs in a previous transmission.

In some examples, for a TB of the one or more TBs, the corresponding CBG-based HARQ-ACK feedback may indicate a NACK(s) for a subset of CBGs of the TB. That is, the CBG-based HARQ-ACK feedback for this TB (denoted as TB #1A for clarity) indicates that the subset of CBGs of TB #1A is not correctly decoded at the UE and may need to be retransmitted. The BS may determine to retransmit TB #1A (e.g., the entire TB #1A or the subset of CBGs (e.g., failed CBG(s)) of TB #1A). In such cases, the second set of TBs scheduled by the DCI for retransmission may include TB #1A.

In some examples, for each CBG of the one or more TBs, the corresponding CBG-based HARQ-ACK feedback may indicate an ACK. That is, all of the one or more TBs is correctly decoded at the UE. In such cases, the first set of TBs may not include any retransmitted TB, but only includes initially transmitted TB.

Whether a TB scheduled by a DCI is initially transmitted or retransmitted can be determined based on a corresponding NDI in the DCI. For example, according to some embodiments of the present disclosure, for an initially transmitted TB in the first set of TBs, the BS may set an NDI corresponding to the TB to indicate that the TB is initially transmitted. In an embodiment of the present disclosure, when the first set of TBs does not include a retransmitted TB, the BS may set the indicator in the DCI to indicate that all CBGs of each TB of the first set of TBs are transmitted in the transmission.

According to some embodiments of the present disclosure, for a retransmitted TB in the first set of TBs, the BS may set an NDI corresponding to the TB to indicate that the TB is retransmitted. In the case that the first set of TBs includes a retransmitted TB(s) (e.g., the second set of TBs), it is up to the BS to set the indicator in the DCI to indicate that all CBGs of each TB of the retransmitted TB(s) are transmitted in the transmission, or only a subset of CBGs of each TB of the retransmitted TB(s) is transmitted. The BS may make such determination based on various principles.

For example, according to some embodiments of the present disclosure, the BS may set the indicator in the DCI to indicate all CBGs of each TB of the first (or second) set of TBs are transmitted in the transmission in response to at least one of the following:
all the first set of TBs are initially transmitted;
a plurality of CBGs (e.g., majority) of all the second set of TBs need to be retransmitted, for example, indicated as not correctly decoded in a previous transmission or responded with NACK in the corresponding CBG-based HARQ-ACK feedback;
all or most of the second set of TBs have a small size;
all or most of the second set of TBs are scheduled by a fallback DCI format (e.g., DCI format 1_0) in a previous transmission;
all or most of the second set of TBs are transmitted without associated scheduling DCI in a previous transmission, e.g., all the second set of TBs are scheduled on SPS PDSCHs; or.
none or a few of CBGs of all the second set of TBs are correctly decoded in a previous transmission or all CBGs of all the second set of TBs are responded with NACK in the corresponding CBG-based HARQ-ACK feedback.

According to some embodiments of the present disclosure, in the case that the BS determines to retransmit all CBGs of each TB in the second set of TBs, the BS may set the indicator in the DCI to indicate that all CBGs of each TB of the second set of TBs are transmitted in the transmission. In the case that the BS determines to retransmit a subset of CBGs of each TB in the second set of TBs, the BS may set the indicator in the DCI to indicate that a subset of CBGs of each TB of the second set of TBs are transmitted in the transmission.

The following descriptions illustrate the operation from the UE side.

In response to receiving the DCI scheduling the first set of TBs, the UE may check NDIs corresponding to the first set of TBs. For example, for a TB in the first set of TBs, the UE may check an NDI corresponding to the TB.

In the case that the NDI indicates that the TB is initially transmitted, in an example, the UE may ignore the indicator in the DCI; in another example, the UE may check the indicator in the DCI. In the case that the NDIs indicate that all the scheduled TBs are initially transmitted, in an example, the UE may ignore the indicator in the DCI; in another example, the UE may check the indicator in the DCI and assume that the indicator indicates that all CBGs of the scheduled TBs are transmitted in the transmission. The UE does not expect that the indicator in the DCI is set to a value indicating only a subset of CBGs of the scheduled TBs is transmitted in the transmission when the NDI indicates that all the scheduled TBs are initially transmitted.

In the case that the NDI indicates that the TB is retransmitted, the UE may check the indicator in the DCI and determine whether all CBGs of the TB are transmitted in the transmission or only a subset of CBGs (e.g., failed CBGs) of the TB is transmitted in the transmission based on the indicator in the DCI.

In such case, when all CBGs of the TB are transmitted in the transmission, the UE may combine all CBGs of the TB received in the transmission with all CBGs of the TB received in a previous transmission for decoding the TB. When only the subset of CBGs of the TB is transmitted in the transmission, the UE may combine the subset of CBGs of the TB received in the transmission with CBG(s) of the TB received in a previous transmission and having the same CBG index(es) as those of the subset of CBGs for further decoding.

It is assumed that TB1 and TB2 are not correctly decoded in previous transmission, wherein CBG1 and CBG2 of TB1 and CBG2 and CBG3 of TB2 are incorrectly decoded while CBG0 and CBG3 of TB1 and CBG0 and CBG1 of TB2 are correctly decoded. It is assumed that the maximum number of TBs schedulable by a DCI is 4 and the maximum number of CBGs per a TB is 4. Consequently, the CBG-based HARQ-ACK feedback for TB1 which is transmitted by the UE and received by the BS may be {A, N, N, A} and the CBG-based feedback for TB2 which is transmitted by the UE and received by the BS may be {A, A, N, N}, wherein “A” denotes an ACK and “N” denotes a NACK.

After receiving the CBG-based HARQ-ACK feedbacks for TB1 and TB2, the BS may determine to schedule the retransmissions of both TB1 and TB2 and initial transmissions of TB3 and TB4 by a DCI.

In some embodiments, TB1 is carried by PDSCH 1, TB2 is carried by PDSCH 2. TB3 is carried by PDSCH 3, and TB4 is carried by PDSCH 4. In an example, the four PDSCHs are scheduled in different slots on the same serving cell (e.g., on the same CC) of the UE as shown in FIG. 2. In another example, the four PDSCHs are scheduled in different serving cells (e.g., on different CCs) of the UE as shown in FIG. 3. It should be noted that although each of PDSCH 1, PDSCH 2, PDSCH 3, and PDSCH 4 is shown as scheduled on a different CC in FIG. 3, two or more of the PDSCHs may be scheduled on the same CCs in some other embodiments of the present disclosure.

The DCI may include 4 NDIs, e.g., “a0, a1, a2, a3,” corresponding to TB1-TB4, respectively. In some examples, a0 corresponds to TB1 and indicates that TB1 is retransmitted, al corresponds to TB2 and indicates that TB2 is retransmitted, a2 corresponds to TB3 and indicates that TB3 is initially transmitted, a3 corresponds to TB4 and indicates that TB4 is initially transmitted.

The DCI may include an indicator “b0” corresponding to both TB1 and TB2. For example, b0 indicates that only a subset of CBGs (e.g., failed CBGs) of each of TB1 and TB2 are transmitted in the transmission.

In response to receiving the DCI scheduling TB1 to TB4, for each TB, the UE may check an NDI corresponding to the TB. For example, for TB3, the UE may check “a2” in the DCI, and since “a2” indicates that TB3 is initially transmitted, the UE may ignore “b0” or may check “b0.”

Similarly, for TB4, the UE may check “a3” in the DCI, and since “a3” indicates that TB4 is initially transmitted, the UE may ignore “b0” or may check “b0”.

For TB1, since the NDI “a0” indicates that TB1 is retransmitted, the UE may check “b0”, and determines that CBG1 and CBG2 of TB1 are retransmitted based on the value of “b0” indicating only failed CBG are transmitted and the previous HARQ-ACK feedback for TB1. Then, the UE may combine CBG1 and CBG2 of TB1 received in the transmission with CBGs with the same indexes as CBG1 and CBG2 received in the previous transmission for further decoding.

Similarly, for TB2, since the NDI “al” indicates that TB2 is retransmitted, the UE may check “b0”, and determines that CBG2 and CBG3 of TB2 are retransmitted based on the value of “b0” indicating only failed CBG are transmitted and the previous HARQ-ACK feedback for TB2. Then, the UE may combine CBG2 and CBG3 of TB2 received in the transmission with CBGs with the same indexes as CBG2 and CBG3 received in the previous transmission for further decoding.

FIG. 5 illustrates exemplary NDIs and an indicator in accordance with some embodiments of the present disclosure. Referring to FIG. 5, all of the NDIs “a0,” “a1”, “a2,” and “a3” may correspond to the same indicator “b0”.

### Embodiment 3

In Embodiment 3, a BS (e.g., BS 102 as shown in FIG. 1) may transmit, to a UE (e.g., UE 101 as shown in FIG. 1), a DCI scheduling a first set of TBs on a set of physical data channels in a transmission. The first set of TBs may include one or more TBs, where each TB of the first set of TBs may be scheduled on a corresponding physical data channel of the set of physical data channels. In some embodiments of the present disclosure, the first set of TBs on the set of physical data channels may be scheduled on different serving cells of the UE or in different slots on the same serving cell of the UE. In some embodiments, the cells (or carriers) on which the set of physical data channels are scheduled may or may not include the cell (or carrier) on which the DCI is transmitted. The transmission may be a DL transmission or a UL transmission. In the case that the transmission is the DL transmission, the set of physical data channels are a set of PDSCHs. In the case that the transmission is the UL transmission, the set of physical data channels are a set of PUSCHs.

The UE may receive, from the BS, the DCI scheduling the first set of TBs on the set of physical data channels.

The DCI may include a field indicating CBG-level transmission information. In some embodiments of the present disclosure, such field may always be include in a DCI regardless of whether the DCI schedules a single physical data channel or a plurality of physical data channels.

In some embodiments of the present disclosure, the first set of TB may include a second set of TBs, wherein the second set of TBs may be a subset of the first set of TBs and are scheduled by the DCI for retransmission in the transmission. That is, the second set of TBs are retransmitted TBs. In some embodiments, the field may indicate CBG-level transmission information for a specific TB of the second set of TBs.

The size of the field may be based on (e.g., equal to or greater than) the maximum number of CBGs per a TB. Since the UE can determine the size of the field, the UE can determine the DCI payload size of the DCI. For example, the field may include a bitmap corresponding to a specific TB (denoted as TB #1B) of the second set of TBs. The size of the bitmap may be based on (e.g., equal to or greater than) the maximum number of CBGs per a TB. Each bit in the bitmap corresponds to a CBG of TB #1B and indicates whether the CBG of TB #1B is transmitted in the transmission.

For example, for a CBG of TB #1B, the corresponding bit “1” in the bitmap may indicate that the CBG of TB #1B is transmitted in the transmission; the corresponding bit “0” in the bitmap may indicate that the CBG of TB #1B is not transmitted in the transmission; or vice versa.

In some embodiments of the present disclosure, the second set of TBs may be ordered according to a predefined rule. For example, in some embodiments of the present disclosure, the TBs in the second set of TBs may be ordered according to associated HARQ process numbers, or associated downlink assignment indicator (DAI) values, or times associated with the TBs in the second set of TBs, or indices of the serving cell on which the TBs in the second set of TBs are scheduled. TB #1B may be a TB located at a specific position of the ordered TBs. For example, TB #1B may be the first TB among the ordered second set of TBs.

For example, the second set of TBs may be ordered according to a predefined order (e.g., an ascending order) of HARQ process numbers associated with the TBs in the second set of TBs. TB #1B is the first one (e.g., the TB with the smallest HARQ process number) among the ordered second set of TBs.

In another example, the second set of TBs may be ordered according to a predefined order (e.g., an ascending order) of DAI values associated with the TBs in the second set of TBs. TB #1B is the first one (e.g., the TB with the smallest DAI value) among the ordered second set of TBs. The DAI value herein may be an actual value without performing a modulo operation. For example, assuming that a DAI field in a DCI format includes 2 bits, a BS may perform a modulo operation on the actual DAI value with 4 (i.e., 22) to obtain the value indicated by the DAI field. The UE can obtain the actual DAI value via an inverse operation on the value indicated by the DAI field.

In another example, the second set of TBs may be ordered according to a predefined order (e.g., an ascending order) of times associated with the second set of TBs. TB #1B is the first one (e.g., the earliest TB received by the UE or transmitted by the BS in the case of DL transmission or the earliest TB transmitted by the UE or received by the BS in the case of UL transmission) among the ordered second set of TBs.

In another example, the second set of TBs may be ordered according to a predefined order of serving cell indices associated with the second set of TBs. TB #1B is the first one among the ordered second set of TBs. In some cases, the predefined order of serving cell indices may be an ascending order of the serving cell indices, TB #1B may be the one with lowest serving cell index among the second set of TBs. In some other cases, the predefined order of serving cell indices may be a descending order of the serving cell indices, TB #1B may be the one with highest serving cell index among the second set of TBs.

The following descriptions illustrate the operations of the BS side and the UE side when the transmission is a DL transmission.

### BS Side

In the case that the transmission is a DL transmission, in some cases, before the current transmission, the BS may receive CBG-based HARQ-ACK feedback for one or more TBs in a previous transmission.

In some examples, for a TB of the one or more TBs, the corresponding CBG-based HARQ-ACK feedback may indicate a NACK(s) for a subset of CBGs of the TB. That is, the CBG-based HARQ-ACK feedback for this TB (denoted as TB #1C for clarity) indicates that the subset of CBGs of TB #1C is not correctly decoded at the UE and may need to be retransmitted. The BS may determine to retransmit TB #1C. In such cases, the second set of TBs scheduled by the DCI for retransmission may include TB #1C.

In the case that the second set of TBs includes at least one TB, the bitmap in the field of the DCI may correspond to a specific TB in the second set of TBs. The method for determine the specific TB as described above may apply here. For example, the BS may set each bit in the bitmap such that each bit may correspond to a CBG of the specific TB and indicates whether the CBG is transmitted. In some embodiment, for the remaining TBs in the second set of TBs, the BS may transmit all CBGs of each TB of the other TBs.

In some examples, for each CBG of the one or more TBs, the corresponding CBG-based HARQ-ACK feedback may indicate an ACK. That is, all of the one or more TBs are correctly decoded at the UE. In such cases, the first set of TBs may not include any retransmitted TB, but only includes the initially transmitted TB. In such cases, the BS may set all bits in the bitmap to indicate that the corresponding CBGs are transmitted in the transmission. For example, all bits in the bitmap may be set to “1”. Whether a TB scheduled by a DCI is initially transmitted or retransmitted can be determined based on a corresponding NDI in the DCI. For example, for an initially transmitted TB in the first set of TBs, the BS may set an NDI corresponding to the TB to indicate that the TB is an initially transmitted TB. For a retransmitted TB in the first set of TBs, the BS may set an NDI corresponding to the TB to indicate that the TB is a retransmitted TB.

### UE Side

In response to receiving the DCI scheduling the first set of TBs, the UE may check an NDI for each of the first set of TBs. In the case that the NDI for each of the first set of TBs indicates that each of the first set of TBs is initially transmitted, in an example, the UE may ignore the bitmap in the DCI; or in another example, the UE may check the bitmap in the DCI and assume that the bitmap indicates that all of the corresponding CBGs are transmitted in the transmission. In such case, the UE does not expect that a bit in the bitmap is set to a value indicating a corresponding CBG is not transmitted in the transmission.

In the case that the NDI for each of the first set of TBs indicates that the first set of TB includes a second set of TBs for retransmission, the bitmap may only apply to a specific TB (e.g., TB #1B) of the second set of TBs. The UE may determine the specific TB according to the method as described above. The UE may check the bitmap in the DCI and determine which CBG(s) of the specific TB are retransmitted in the transmission. Then, the UE may combine the retransmitted CBG(s) of the specific TB in the transmission with a CBG(s) of the specific TB which is received in a previous transmission and has the same CBG index(es) as those of the retransmitted CBG(s) for further decoding. The UE may determine that the remaining TBs of the second set of TBs are transmitted on a TB-based retransmission.

The following example illustrates the operations of the BS and the UE when the transmission is a DL transmission.

It is assumed that TB1 and TB2 are not correctly decoded in previous transmission, wherein CBG1 and CBG2 of TB1 and CBG2 and CBG3 of TB2 are incorrectly decoded while CBG0 and CBG3 of TB1 and CBG0 and CBG1 of TB2 are correctly decoded. It is assumed that the maximum number of TBs schedulable by a DCI is 4 and the maximum number of CBGs per a TB is 4. Consequently, the CBG-based HARQ-ACK feedback for TB1 which is transmitted by the UE and received by the BS may be {A, N, N, A} and the CBG-based feedback for TB2 which is transmitted by the UE and received by the BS may be {A, A, N, N}, wherein “A” denotes an ACK and “N” denotes a NACK.

After receiving the CBG-based HARQ-ACK feedbacks for TB1 and TB2, the BS may determine to schedule the retransmissions of both TB1 and TB2 and initial transmissions of TB3 and TB4 by a DCI.

In some embodiments, TB1 is carried by PDSCH 1, TB2 is carried by PDSCH 2, TB3 is carried by PDSCH 3, and TB4 is carried by PDSCH 4. In an example, the four PDSCHs are scheduled in different slots on the same serving cell (e.g., on the same CC) of the UE as shown in FIG. 2. In another example, the four PDSCHs are scheduled in different serving cells (e.g., on different CCs) of the UE as shown in FIG. 3. It should be noted that although each of PDSCH 1, PDSCH 2, PDSCH 3, and PDSCH 4 is shown as scheduled on a different CC in FIG. 3, two or more of the PDSCHs may be scheduled on the same CCs in some other embodiments of the present disclosure.

The DCI may include 4 NDIs, e.g., “a0, a1, a2, a3.” corresponding to TB1-TB4, respectively. In some examples, a0 corresponds to TB1 and indicates that TB1 is retransmitted, al corresponds to TB2 and indicates that TB2 is retransmitted, a2 corresponds to TB3 and indicates that TB3 is initially transmitted, a3 corresponds to TB4 and indicates that TB4 is initially transmitted.

Assuming that TB1 is the specific TB in TB1 and TB2 determined based on the above methods, then the DCI may include a bitmap “b0, b1, b2, b3” corresponding to TB1, wherein b0 corresponds to CBG0 of TB1 and indicates that CBG0 of TB1 is not retransmitted, b1 corresponds to CBG1 of TB1 and indicates that CBG1 of TB1 is retransmitted, b2 corresponds to CBG2 of TB1 and indicates that CBG2 of TB1 is retransmitted, and b3 corresponds to CBG0 and indicates that CBG3 of TB1 is not retransmitted.

In response to receiving the DCI scheduling TB1 to TB4, for each TB, the UE may check an NDI corresponding to the TB. The UE may determine that TB1 is the specific retransmitted TB. The UE may check bitmap “b0, b1, b2, b3” corresponding to TB1 and may determine that that CBG1 and CBG2 of TB1 are retransmitted based on the bitmap. Then, the UE may combine CBG1 and CBG2 of TB1 received in the transmission with CBGs with the same indexes as CBG1 and CBG2 received in the previous transmission for further decoding. In some embodiments, the UE may receive all CBGs of TB2.

FIG. 6 illustrates exemplary NDIs and a bitmap in accordance with some other embodiments of the present disclosure. Referring to FIG. 6, NDI “a0” may correspond to bitmap “b0, b1, b2, b3.” For example, the UE may check NDI “a0” corresponding to the specific retransmitted TB (e.g., TB1) and check the bitmap “b0, b1, b2, b3” corresponding to TB1.

The following descriptions illustrate the operations of the BS side and the UE side when the transmission is a UL transmission.

### BS Side

In the case that the transmission is a UL transmission, in some cases, the first set of TBs scheduled by the DCI may not include any retransmitted TB, but only includes initially transmitted TB. In such cases, the BS may set all bits in the bitmap to indicate that all of the corresponding CBGs are transmitted in the transmission. For example, all bits in the bitmap may be set to “1”.

In some other cases, the first set of TBs scheduled by the DCI may include a second of TBs for retransmission. In such cases, the bitmap in the field of the DCI may correspond to a specific TB in the second set of TBs, the BS may set each bit in the bitmap such that each bit may correspond to a CBG of the specific TB and indicates whether the CBG is transmitted in the transmission.

In the above cases, for an initially transmitted TB in the first set of TBs, the BS may set an NDI corresponding to the TB to indicate that the TB is an initially transmitted TB. For a retransmitted TB in the first set of TBs, the BS may set an NDI corresponding to the TB to indicate that the TB is a retransmitted TB.

### UE Side

In response to receiving the DCI scheduling the first set of TBs, the UE may check an NDI for each of the first set of TBs. In the case that the NDI for each of the first set of TBs indicates that each of the first set of TBs is initially transmitted, in an example, the UE may ignore the bitmap in the DCI; or in another example, the UE may check the bitmap in the DCI and assume that the bitmap indicates that all of the corresponding CBGs are transmitted in the transmission. In such case, the UE does not expect that the bitmap is set to indicate that only a subset of CBGs is transmitted in the transmission. In such cases, the UE may transmit all CBGs of each TB of the first set of TBs to the BS.

In the case that the NDI for each of the first set of TBs indicates that the first set of TB includes a second set of TBs for retransmission, the bitmap may only apply to a specific TB (e.g., TB #1B) of the second set of TBs. The UE may determine the specific TB according to the method as described above. The UE may check the bitmap in the DCI and determine which CBG(s) of the specific TB are to be retransmitted in the transmission. Then, the UE may transmit the CBG(s) of the TB which is indicated to be transmitted by the bitmap to the BS.

### Embodiment 4

In Embodiment 4, a BS (e.g., BS 102 as shown in FIG. 1) may transmit, to a UE (e.g., UE 101 as shown in FIG. 1), a DCI scheduling a first set of TBs on a set of physical data channels in a transmission. The first set of TBs may include one or more TBs, where each TB of the first set of TBs may be scheduled on a corresponding physical data channel of the set of physical data channels. In some embodiments of the present disclosure, the first set of TBs on the set of physical data channels may be scheduled on different serving cells of the UE or in different slots on the same serving cell of the UE. In some embodiments, the cells (or carriers) on which the set of physical data channels are scheduled may or may not include the cell (or carrier) on which the DCI is transmitted. The transmission may be a DL transmission or a UL transmission. In the case that the transmission is the DL transmission, the set of physical data channels are a set of PDSCHs. In the case that the transmission is the UL transmission, the set of physical data channels are a set of PUSCHs.

The UE may receive, from the BS, the DCI scheduling the first set of TBs on the set of physical data channels.

The DCI may include a field indicating CBG-level transmission information. In some embodiments of the present disclosure, such field may always be include in a DCI regardless of whether the DCI schedules a single physical data channel or a plurality of physical data channels.

In some embodiments of the present disclosure, the first set of TBs may include a second set of TBs, wherein the second set of TBs may be a subset of the first set of TBs and are scheduled by the DCI for retransmission in the transmission. That is, the second set of TBs are retransmitted TBs. In some embodiments, the field may indicate CBG-level transmission information for one or two TBs of the second set of TBs. The size of the field may be based on (e.g., equal to or greater than) the maximum number of CBGs per a TB. Since the UE can determine the size of the field, the UE can determine the DCI payload size of the DCI.

For example, the second set of TBs may only include a single TB. The field may include a bitmap corresponding to the single TB. The size of the bitmap may be based on (e.g., equal to or greater than) the maximum number of CBGs per a TB. Each bit in the bitmap corresponds to a CBG of the single TB of the second set of TBs and indicates whether the CBG of the TB is transmitted in the transmission. For example, bit “1” in the bitmap may indicate that the corresponding CBG of the TB is transmitted in the transmission; bit “0” in the bitmap may indicate that the corresponding CBG of the TB is not transmitted in the transmission; or vice versa.

In another example, the second set of TBs may only include two TBs. Then, the field may indicate CBG-level transmission information for the two TBs. In such embodiments, the bitmap corresponds to the two TBs, each bit in the bitmap corresponds to a number of consecutive CBGs (e.g., two consecutive CBGs) of a TB of two TBs and indicates whether the number of consecutive CBGs of the TB is transmitted in the transmission. For example, bit “1” in the bitmap may indicate that a number of consecutive CBGs corresponding to the bit are transmitted in the transmission; bit “0” in the bitmap may indicate that a number of consecutive CBGs corresponding to the bit are not transmitted in the transmission; or vice versa.

For example, assuming that the maximum number of CBGs per a TB is 4 and the bitmap include 4 bits, then the first two bits of the bitmap may correspond to one (denotes as TB #A) of the two TBs and the last two bits of the bitmap may correspond to the other (denotes as TB #B) of the two TBs. The first two bits of the bitmap may correspond to the first two CBGs and the last two CBGs of TB #A, respectively. The last two bits of the bitmap may correspond to the first two CBGs and the last two CBGs of TB #B, respectively.

In another example, the second set of TBs may include more than two TBs. Then, the field may indicate CBG-level transmission information for two TBs (denoted as TB #1D and TB #2D) in the second set of TBs. In such embodiments, the bitmap corresponds to a number of consecutive CBGs of TB #1D or TB #2D of the second set of TBs and indicates whether the number of consecutive CBGs of TB #1D or TB #2D are transmitted in the transmission. For example, bit “1” in the bitmap may indicate that the number of consecutive CBGs corresponding to the bit are transmitted in the transmission; bit “0” in the bitmap may indicate that the number of consecutive CBGs corresponding to the bit are not transmitted in the transmission; or vice versa.

Various methods may be employed to determine TB #1D or TB #2D in the second set of TBs. For example, the second set of TBs may be ordered according to a predefined rule. TB #1D or TB #2D may be a TB located at a specific position of the ordered TBs. For example, TB #1D and TB #2D may be the first and second TBs among the ordered second set of TBs.

For example, in some embodiments of the present disclosure, TBs in the second set of TBs are ordered according to associated HARQ process numbers, or associated downlink assignment indicator (DAI) values, or times associated with the TBs in the second set of TBs, or indices of the serving cell on which the TBs in the second set of TBs are scheduled. The ordering methods described in Embodiment 3 may apply here. TB #1D may be the first one among the ordered second set of TBs. TB #2D may be a TB immediately following TB #1D among the ordered second set of TBs.

The following descriptions illustrate the operations of the BS side and the UE side when the transmission is a DL transmission.

### BS Side

In the case that the transmission is a DL transmission, in some cases, before the current transmission, the BS may receive CBG-based HARQ-ACK feedback for one or more TBs in a previous transmission.

In some examples, for a TB of the one or more TBs, the corresponding CBG-based HARQ-ACK feedback may indicate NACK(s) for a subset of CBGs of the TB. That is, the CBG-based HARQ-ACK feedback for this TB (denoted as TB #1E for clarity) indicates that the subset of CBGs of TB #1E is not correctly decoded at the UE and may need to be retransmitted.

The BS may determine to retransmit TB #1E. In such cases, the second set of TBs scheduled by the DCI for retransmission may include TB #1E.

In the case that the BS determines to retransmit a single TB, the bitmap in the field of the DCI may correspond to the single TB, the BS may set each bit in the bitmap such that each bit may correspond to a CBG of the single TB and indicates whether the CBG is transmitted.

In the case that the BS determines to retransmit two TBs, the BS may include the two TBs in the first set of TBs. In such cases, the second set of TBs scheduled by the DCI for retransmission may include the two TBs. The bitmap in the field of the DCI may correspond to the two TBs, the BS may set each bit in the bitmap such that each bit may correspond to a number of consecutive CBGs (e.g., two consecutive CBGs) of a TB of the two TBs and indicates whether the number of consecutive CBGs are transmitted.

In the case that the BS determines to retransmit more than two TBs, the BS may include the more than two TBs in the first set of TBs. In such cases, the second set of TBs scheduled by the DCI for retransmission may include more than two TBs. The bitmap in the field of the DCI may correspond to two specific TBs of the more than two TBs, the BS may set each bit in the bitmap such that each bit may correspond to a number of consecutive CBGs (e.g., two consecutive CBGs) of one of the two specific TBs and indicates whether the number of consecutive CBGs are transmitted.

In some examples, for each CBG of the one or more TBs, the corresponding CBG-based HARQ-ACK feedback may indicate an ACK. That is, all of the one or more TBs are correctly decoded at the UE. In such cases, the first set of TBs may not include any retransmitted TB, but only includes initially transmitted TB. In such cases, the BS may set all bits in the bitmap to indicate that all of the corresponding CBGs are transmitted in the transmission. For example, all bits in the bitmap may be set to “1”.

Whether a TB scheduled by a DCI is initially transmitted or retransmitted can be determined based on a corresponding NDI in the DCI. For example, for an initially transmitted TB in the first set of TBs, the BS may set an NDI corresponding to the TB to indicate that the TB is an initially transmitted TB. For a retransmitted TB in the first set of TBs, the BS may set an NDI corresponding to the TB to indicate that the TB is a retransmitted TB.

### UE Side

In response to receiving the DCI scheduling the first set of TBs, the UE may check an NDI for each of the first set of TBs. In the case that the NDI for each of the first set of TBs indicates that each of the first set of TBs is initially transmitted, in an example, the UE may ignore the bitmap in the DCI; or in another example, the UE may check the bitmap in the DCI and assume that the bitmap indicates that all of the corresponding CBGs are transmitted in the transmission. In such case, the UE does not expect that the bitmap is set to indicate that only a subset of CBGs is transmitted in the transmission.

In the case that the NDI for each of the first set of TBs indicates that only one TB is retransmitted, the UE may check the bitmap in the DCI and determine which CBG(s) of the one TB are retransmitted in the transmission. Then, the UE may combine the retransmitted CBG(s) of the one TB in the transmission with a CBG(s) of the one TB which is received in a previous transmission and has the same CBG index(es) as those of the retransmitted CBG(s) for further decoding.

In the case that the NDI for each of the first set of TBs indicates that only two TBs are retransmitted, the UE may check the bitmap in the DCI and determine which CBG group(s) (e.g., each group includes a number of consecutive CBGs) of the two TBs are retransmitted in the transmission. Then, for a retransmitted CBG in a retransmitted CBG group of a TB, the UE may combine the retransmitted CBG with a CBG of the TB which is received in a previous transmission and has the same CBG index as that of the retransmitted CBG for further decoding.

In the case that the NDI for each of the first set of TBs indicates that more than two TBs are retransmitted, the UE may check the bitmap in the DCI and determine which CBG group(s) (e.g., each group includes a number of consecutive CBGs) of two specific TBs of the more than two TBs are retransmitted in the transmission. The above method for determine the two specific TBs among the more than two TBs may apply here. Then, for a retransmitted CBG in a retransmitted CBG group of one of the two specific TBs, the UE may combine the retransmitted CBG with a CBG of the one of the two specific TBs which is received in a previous transmission and has the same CBG index as that of the retransmitted CBG for further decoding.

The following example illustrates the operations of the BS and the UE when the transmission is a DL transmission.

It is assumed that TB1 and TB2 are not correctly decoded in previous transmission, wherein CBG1 and CBG2 of TB1 and CBG2 and CBG3 of TB2 are incorrectly decoded while CBG0 and CBG3 of TB1 and CBG0 and CBG1 of TB2 are correctly decoded. It is assumed that the maximum number of TBs schedulable by a DCI is 4 and the maximum number of CBGs per a TB is 4. Consequently, the CBG-based HARQ-ACK feedback for TB1 which is transmitted by the UE and received by the BS may be {A, N, N, A} and the CBG-based feedback for TB2 which is transmitted by the UE and received by the BS may be {A, A, N, N}, wherein “A” denotes an ACK and “N” denotes a NACK.

After receiving the CBG-based HARQ-ACK feedbacks for TB1 and TB2, the BS may determine to schedule the retransmissions of both TB1 and TB2 and initial transmissions of TB3 and TB4 by a DCI.

In some embodiments, TB1 is carried by PDSCH 1, TB2 is carried by PDSCH 2. TB3 is carried by PDSCH 3, and TB4 is carried by PDSCH 4. In an example, the four PDSCHs are scheduled in different slots on the same serving cell (e.g., on the same CC) of the UE as shown in FIG. 2. In another example, the four PDSCHs are scheduled in different serving cells (e.g., on different CCs) of the UE as shown in FIG. 3. It should be noted that although each of PDSCH 1, PDSCH 2, PDSCH 3, and PDSCH 4 is shown as scheduled on a different CC in FIG. 3, two or more of the PDSCHs may be scheduled on the same CCs in some other embodiments of the present disclosure.

The DCI may include 4 NDIs, e.g., “a0, a1, a2, a3,” corresponding to TB1-TB4, respectively. In some examples, a0 corresponds to TB1 and indicates that TB1 is retransmitted, al corresponds to TB2 and indicates that TB2 is retransmitted, a2 corresponds to TB3 and indicates that TB3 is initially transmitted, a3 corresponds to TB4 and indicates that TB4 is initially transmitted.

DCI may include a bitmap “b0, b1, b2, b3” corresponding to TB1 and TB2, wherein b0 corresponds to CBG0 and CBG1 of TB1 and indicates that CBG0 and CBG1 of TB1 are retransmitted, b1 corresponds to CBG2 and CBG3 of TB1 and indicates that CBG2 and CBG3 of TB1 are retransmitted, b2 corresponds to CBG0 and CBG1 of TB2 and indicates that that CBG0 and CBG1 of TB2 are not retransmitted, and b3 corresponds to CBG2 and CBG3 of TB2 and indicates that CBG2 and CBG3 of TB2 are retransmitted.

In response to receiving the DCI scheduling TB1 to TB4, for each TB, the UE may check an NDI corresponding to the TB. The UE may determine that there are two retransmitted TBs (e.g., TB1 and TB2) based on the NDI. Then, the UE may check bitmap “b0, b1, b2, b3” corresponding to TB1 and TB2. The UE may determine that CBG0, CBG1, CBG2 and CBG3 of TB1 are retransmitted and CBG2 and CBG3 of TB2 are retransmitted. Then, for a retransmitted CBG of a TB1 or TB2, the UE may combine the retransmitted CBG with a CBG of TB1 or TB2 which is received in a previous transmission and has the same CBG index as that of the retransmitted CBG for decoding the corresponding TB.

FIG. 7 illustrates exemplary NDIs and a bitmap in accordance with some other embodiments of the present disclosure. Referring to FIG. 7, NDI “a0” may correspond to the bitmap “b0 and b1” and NDI “a1” may correspond to the bitmap “b2 and b3”.

In the above example, the BS determines to schedule the retransmissions of both TB1 and TB2 by a DCI. However, in some other examples, the BS may determine to only schedule TB1 for retransmission with other initially transmitted TBs by a DCI. Since TB1 is the only retransmitted TB, then the bitmap “b0 b1 b2 b3” corresponds to TB1, where b0 is set to indicate that CBG0 of TB1 is not retransmitted, bl is set to indicate that CBG1 of TB1 is retransmitted, b2 is set to indicate that CBG2 of TB1 is retransmitted, where b3 is set to indicate that CBG3 of TB1 is not retransmitted.

The following descriptions illustrate the operations of the BS side and the UE side when the transmission is a UL transmission.

### BS Side

In the case that the transmission is a UL transmission, in some cases, the first set of TBs scheduled by the DCI may not include any retransmitted TB, but only includes initially transmitted TB. In such cases, the BS may set all bits in the bitmap to indicate that all of the corresponding CBGs are transmitted in the transmission. For example, all bits in the bitmap may be set to “1”.

In some other cases, the first set of TBs scheduled by the DCI may include one TB for retransmission. In such cases, the bitmap in the field of the DCI may correspond to the one TB, the BS may set each bit in the bitmap such that each bit may correspond to a CBG of the one TB and indicates whether the CBG is transmitted in the transmission.

In some other cases, the first set of TBs scheduled by the DCI may include two TBs for retransmission. In such cases, the bitmap in the field of the DCI may correspond to the two TBs, the BS may set each bit in the bitmap such that each bit may correspond to a number of consecutive CBGs of a TB of the two TBs and indicates whether the number of consecutive CBGs are transmitted in the transmission.

In some other cases, the first set of TBs scheduled by the DCI may include more than two TBs for retransmission. In such cases, the bitmap in the field of the DCI may correspond to two of the more than two TBs. The above method for determine the two specific TBs among the more than two TBs may apply here. The BS may set each bit in the bitmap such that each bit may correspond to a number of consecutive CBGs of one of the two specific TBs and indicates whether the number of consecutive CBGs are transmitted.

In the above cases, for an initially transmitted TB in the first set of TBs, the BS may set an NDI corresponding to the TB to indicate that the TB is an initially transmitted TB. For a retransmitted TB in the first set of TBs, the BS may set an NDI corresponding to the TB to indicate that the TB is a retransmitted TB.

### UE Side

In response to receiving the DCI scheduling the first set of TBs, the UE may check an NDI for each of the first set of TBs. In the case that the NDI for each of the first set of TBs indicates that each of the first set of TBs is initially transmitted, in an example, the UE may ignore the bitmap in the DCI; or in another example, the UE may check the bitmap in the DCI and assume that the bitmap indicates that all of the corresponding CBGs are transmitted in the transmission. In such case, the UE does not expect that the bitmap is set to indicate that only a subset of CBGs is transmitted in the transmission. In such cases, the UE may transmit all CBGs of each TB of the first set of TBs to the BS.

In the case that the NDI for each of the first set of TBs indicates that the first set of TBs includes only one TB for retransmission, the UE may check the bitmap in the DCI and determine which CBG(s) of the one TB are to be retransmitted in the transmission. Then, the UE may transmit the CBG(s) of the TB which is indicated to be retransmitted by the bitmap to the BS.

In the case that the NDI for each of the first set of TBs indicates that the first set of TB includes only two TBs for retransmission, the UE may check the bitmap in the DCI and determine which CBG group(s) (e.g., each group includes a number of consecutive CBGs) of the two TBs are to be retransmitted in the transmission. Then, the UE may transmit the CBG group(s) of the two TBs which is indicated to be retransmitted by the bitmap to the BS.

In the case that the NDI for each of the first set of TBs indicates that the first set of TB includes more than two TBs for retransmission, the UE may check the bitmap in the DCI and determine which CBG group(s) (e.g., each group includes a number of consecutive CBGs) of two specific TBs of the more than two TBs are to be retransmitted in the transmission. The above method for determine the two specific TBs among the more than two TBs may apply here. Then, the UE may transmit the CBGs in the CBG group(s) of the two specific TBs which is indicated to be retransmitted by the bitmap to the BS.

### Embodiment 5

In Embodiment 5, a BS (e.g., BS 102 as shown in FIG. 1) may transmit, to a UE (e.g., UE 101 as shown in FIG. 1), a DCI scheduling a first set of TBs on a set of physical data channels in a transmission. The first set of TBs may include one or more TBs, where each TB of the first set of TBs may be scheduled on a corresponding physical data channel of the set of physical data channels. In some embodiments of the present disclosure, the first set of TBs on the set of physical data channels may be scheduled on different serving cells of the UE or in different slots on the same serving cell of the UE. In some embodiments, the cells (or carriers) on which the set of physical data channels are scheduled may or may not include the cell (or carrier) on which the DCI is transmitted. The transmission may be a DL transmission or a UL transmission. In the case that the transmission is the DL transmission, the set of physical data channels are a set of PDSCHs. In the case that the transmission is the UL transmission, the set of physical data channels are a set of PUSCHs.

The UE may receive, from the BS, the DCI scheduling the first set of TBs on the set of physical data channels.

The DCI may include a field indicating CBG-level transmission information. In some embodiments of the present disclosure, such field may always be include in a DCI regardless of whether the DCI schedules a single physical data channel or a plurality of physical data channels.

In some embodiments of the present disclosure, the first set of TB may include a second set of TBs, wherein the second set of TBs may be a subset of the first set of TBs and are scheduled by the DCI for retransmission in the transmission. That is, the second set of TBs are retransmitted TBs. In some embodiments, the field may indicate CBG-level transmission information for the second set of TBs. The size of the field may be based on (e.g., equal to or greater than) the maximum number of CBGs per a TB. Since the UE can determine the size of the field, the UE can determine the DCI payload size of the DCI.

For example, the field may include a bitmap corresponding to the second set of TBs. The size of the bitmap may be based on (e.g., equal to or greater than) the maximum number of CBGs per a TB. Each bit in the bitmap corresponds to a CBG index and indicates whether a CBG(s) of TB(s) of the second set of TBs with the CBG index is transmitted in the transmission. For example, for a CBG index, bit “1” in the bitmap may indicate that all the CBGs of the TBs in the second set of TBs with the CBG index are transmitted in the transmission; bit “0” in the bitmap may indicate that all the CBGs of the TBs in the second set of TBs with the CBG index are not transmitted in the transmission; or vice versa.

The following descriptions illustrate the operations of the BS side and the UE side when the transmission is a DL transmission.

### BS Side

In the case that the transmission is a DL transmission, in some cases, before the current transmission, the BS may receive CBG-based HARQ-ACK feedback for one or more TBs in a previous transmission.

In some examples, for a TB of the one or more TBs, the corresponding CBG-based HARQ-ACK feedback may indicate NACK(s) for a subset of CBGs of the TB. That is, the CBG-based HARQ-ACK feedback for this TB (denoted as TB #1F for clarity) indicates that the subset of CBGs of TB #1F is not correctly decoded at the UE and may need to be retransmitted.

The BS may determine to retransmit TB #1F (e.g., the entire TB #1F or the subset of CBGs (e.g., failed CBG(s)) of TB #1F). In such cases, the second set of TBs scheduled by the DCI for retransmission may include TB #1F.

It is assumed that the BS determines to retransmit at least one TB (e.g., the second set of TBs). For a given CBG index, as long as the BS intends to retransmit a CBG with the given CBG index of a TB in the at least one TB, the BS may retransmit all the CBGs of the at least one TBs with the given CBG index and set the corresponding bit to indicate that a CBG(s) of TB(s) of the at least one TBs with the given CBG index is transmitted.

Only when the BS intends to not retransmit all the CBGs of the at least one TBs with the given CBG index, the BS may not transmit all the CBGs of the at least one TBs with the given CBG index and set the corresponding bit to indicate that a CBG(s) of TB(s) of the at least one TBs with the given CBG index is not transmitted.

In some examples, for each CBG of the one or more TBs, the corresponding CBG-based HARQ-ACK feedback may indicate an ACK. That is, all of the one or more TBs are correctly decoded at the UE. In such cases, the first set of TBs may not include any retransmitted TB, but only includes initially transmitted TB. In such cases, the BS may set all bits in the bitmap to indicate that all of the corresponding CBGs are transmitted in the transmission. For example, all bits in the bitmap may be set to “1”.

Whether a TB scheduled by a DCI is initially transmitted or retransmitted can be determined based on a corresponding NDI in the DCI. For example, for an initially transmitted TB in the first set of TBs, the BS may set an NDI corresponding to the TB to indicate that the TB is an initially transmitted TB. For a retransmitted TB in the first set of TBs, the BS may set an NDI corresponding to the TB to indicate that the TB is a retransmitted TB.

### UE Side

In response to receiving the DCI scheduling the first set of TBs, the UE may check an NDI for each of the first set of TBs. In the case that the NDI for each of the first set of TBs indicates that each of the first set of TBs is initially transmitted, in an example, the UE may ignore the bitmap in the DCI; or in another example, the UE may check the bitmap in the DCI and assume that the bitmap indicates that all of the corresponding CBGs are transmitted in the transmission. In such case, the UE does not expect that a bit in the bitmap is set to a value indicating a corresponding CBG(s) is not transmitted in the transmission.

In the case that the NDI for each of the first set of TBs indicates that at least one TB of the first set of TBs is retransmitted, the UE may determine that the bitmap corresponds to all of the at least one TB. The UE may check the bitmap in the DCI and determine which CBG(s) of the at least one TB is retransmitted in the transmission. Then, for a retransmitted CBG of a TB, the UE may combine the retransmitted CBG of the TB in the transmission with a CBG of the TB which is received in a previous transmission and has the same CBG index as that of the retransmitted CBG for further decoding.

The following example illustrates the operations of the BS and the UE when the transmission is a DL transmission.

It is assumed that TB1 and TB2 are not correctly decoded in previous transmission, wherein CBG1 and CBG2 of TB1 and CBG2 and CBG3 of TB2 are incorrectly decoded while CBG0 and CBG3 of TB1 and CBG0 and CBG1 of TB2 are correctly decoded. It is assumed that the maximum number of TBs schedulable by a DCI is 4 and the maximum number of CBGs per a TB is 4. Consequently, the CBG-based HARQ-ACK feedback for TB1 which is transmitted by the UE and received by the BS may be {A, N, N, A} and the CBG-based feedback for TB2 which is transmitted by the UE and received by the BS may be {A, A, N, N}, wherein “A” denotes an ACK and “N” denotes a NACK.

After receiving the CBG-based HARQ-ACK feedbacks for TB1 and TB2. the BS may determine to schedule the retransmissions of both TB1 and TB2 and initial transmissions of TB3 and TB4 by a DCI.

In some embodiments, TB1 is carried by PDSCH 1, TB2 is carried by PDSCH 2, TB3 is carried by PDSCH 3, and TB4 is carried by PDSCH 4. In an example, the four PDSCHs are scheduled in different slots on the same serving cell (e.g., on the same CC) of the UE as shown in FIG. 2. In another example, the four PDSCHs are scheduled in different serving cells (e.g., on different CCs) of the UE as shown in FIG. 3. It should be noted that although each of PDSCH 1, PDSCH 2, PDSCH 3, and PDSCH 4 is shown as scheduled on a different CC in FIG. 3, two or more of the PDSCHs may be scheduled on the same CCs in some other embodiments of the present disclosure.

The DCI may include 4 NDIs, e.g., “a0, a1, a2, a3,” corresponding to TB1-TB4, respectively. In some examples, a0 corresponds to TB1 and indicates that TB1 is retransmitted, al corresponds to TB2 and indicates that TB2 is retransmitted, a2 corresponds to TB3 and indicates that TB3 is initially transmitted, a3 corresponds to TB4 and indicates that TB4 is initially transmitted

DCI may include a bitmap “b0, b1, b2, b3” corresponding to TB1 and TB2, wherein b0 corresponds to a CBG index 0 and indicates that CBG0 of TB1 and CBG0 of TB2 are not retransmitted, bl corresponds to a CBG index 1 and indicates that CBG1 of TB1 and CBG1 of TB2 are retransmitted, b2 corresponds to a CBG index 2 and indicates that CBG2 of TB1 and CBG2 of TB2 are retransmitted, and b3 corresponds to a CBG index 3 and indicates that CBG3 of TB1 and CBG3 of TB2 are retransmitted.

In response to receiving the DCI scheduling TB1 to TB4, for each TB, the UE may check an NDI corresponding to the TB. The UE may determine that there are two retransmitted TBs (e.g., TB1 and TB2) based on the NDI. Then, the UE may check bitmap “b0, b1, b2, b3” corresponding to TB1 and TB2. The UE may determine that CBG1 of TB1 and CBG1 of TB2, CBG2 of TB1 and CBG2 of TB2, and CBG3 of TB1 and CBG3 of TB2 are retransmitted. Then, for a retransmitted CBG of a TB1 or TB2, the UE may combine the retransmitted CBG with a CBG of TB1 or TB2 which is received in a previous transmission and has the same CBG index as that of the retransmitted CBG for decoding the corresponding TB.

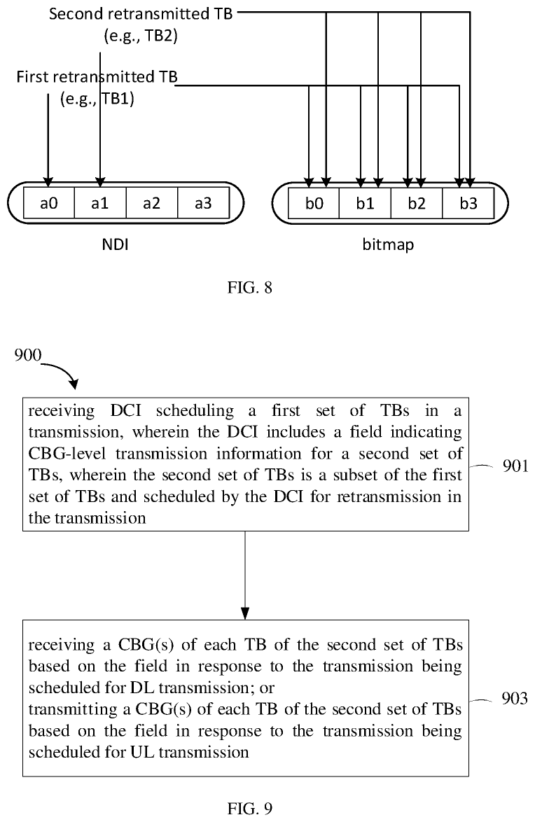

FIG. 8 illustrates exemplary NDIs and a bitmap in accordance with some other embodiments of the present disclosure. Referring to FIG. 8, NDI “a0” may correspond to the bitmap “b0, b1, b2, b3” and NDI “al” may also correspond to the bitmap “b0, b1, b2, b3”. For example, the UE may first check NDI “a0” corresponding to TB1 and then check the bitmap “b0, b1, b2, b3” corresponding to TB1. Similarly, the UE may first check NDI “al” corresponding to TB2 and then check the bitmap “b0, b1, b2, b3” corresponding to TB2.

In the above example, the BS determines to schedule the retransmissions of both TB1 and TB2 by a DCI. However, in some other examples, the BS may determine to only schedule TB1 for retransmission with other initially transmitted TBs by a DCI. Since TB1 is the only retransmitted TB, then the bitmap “b0 b1 b2 b3” corresponds to TB1, where b0 corresponds to a CBG index 0 and is set to indicate that CBG0 of TB1 is not retransmitted, b1 corresponds to a CBG index 1 and is set to indicate that CBG1 of TB1 is retransmitted, b2 corresponds to a CBG index 2 and is set to indicate that CBG2 of TB1 is retransmitted, and b3 corresponds to a CBG index 3 and is set to indicate that CBG3 of TB1 is not retransmitted.

The following descriptions illustrate the operations of the BS side and the UE side when the transmission is a UL transmission.

### BS Side

In the case that the transmission is a UL transmission, in some cases, the first set of TBs scheduled by the DCI may not include any retransmitted TB, but only includes initially transmitted TB. In such cases, the BS may set all bits in the bitmap to indicate that all of the corresponding CBGs are transmitted in the transmission. For example, all bits in the bitmap may be set to “1”.

In some other cases, the first set of TBs scheduled by the DCI may include at least one TB for retransmission. In such cases, the bitmap in the field of the DCI may correspond to the at least one TB, the BS may set each bit in the bitmap such that each bit may correspond to a CBG index and indicate whether a CBG(s) of TB(s) of the at least one TB with the CBG index is transmitted in the transmission.

In the above cases, for an initially transmitted TB in the first set of TBs, the BS may set an NDI corresponding to the TB to indicate that the TB is an initially transmitted TB. For a retransmitted TB in the first set of TBs, the BS may set an NDI corresponding to the TB to indicate that the TB is a retransmitted TB.

### UE Side

In response to receiving the DCI scheduling the first set of TBs, the UE may check an NDI for each of the first set of TBs. In the case that the NDI for each of the first set of TBs indicates that each of the first set of TBs is initially transmitted, in an example, the UE may ignore the bitmap in the DCI; or in another example, the UE may check the bitmap in the DCI and assume that the bitmap indicates that all of the corresponding CBGs are transmitted in the transmission. In such case, the UE does not expect that the bitmap is set to indicate that only a subset of CBGs of each TB of the first set of TBs is transmitted in the transmission. In such cases, the UE may transmit all CBGs of each TB of the first set of TBs to the BS.

In the case that the NDI for each of the first set of TBs indicates that the first set of TB includes at least one TB for retransmission, the UE may check the bitmap in the DCI and determine which CBG(s) of the at least one TB are to be retransmitted in the transmission. Then, the UE may transmit the CBG(s) of the at least one TB which is indicated to be retransmitted by the bitmap to the BS.

FIG. 9 is a flow chart illustrating an exemplary method for CBGTI indication in a DCI according to some embodiments of the present disclosure. The method in FIG. 9 may be implemented by a UE (e.g., UE 101 as shown in FIG. 1).

In the exemplary method shown in FIG. 9, in step 901, the UE may receive, from a BS (e.g., BS 102 as shown in FIG. 1), a DCI scheduling a first set of TBs in a transmission. The DCI may include a field indicating CBG-level transmission information for a second set of TBs, wherein the second set of TBs is a subset of the first set of TBs and scheduled by the DCI for retransmission in the transmission.

In step 903, the UE may receive a CBG(s) of each TB of the second set of TBs based on the field in response to the transmission being scheduled for DL transmission in response to the transmission being scheduled for DL transmission. For example, the specific operation in this step may refer to Embodiments 1-5.

Alternatively, in step 903, the UE may transmit a CBG(s) of each TB of the second set of TBs based on the field in response to the transmission being scheduled for UL transmission. For example, the specific operation in this step may refer to Embodiments 3-5.

In some embodiments of the present disclosure, the field may include a bitmap and a size of the bitmap is based on a maximum number of TBs schedulable by the DCI. For example, the definitions regarding the bitmap may refer to Embodiment 1. In an embodiment, each bit of the bitmap corresponds to a TB of the second set of TBs and indicates whether all CBGs or only a subset of CBGs of the TB are transmitted in the transmission. In another embodiment, each bit of the bitmap corresponds to a TB of the first set of TBs and indicates whether all CBGs or only a subset of CBGs of the TB are transmitted in the transmission.

In some embodiments of the present disclosure, the field may include an indicator indicating whether all CBGs or only a subset of CBGs of each TB of the second set of TBs are transmitted. For example, the definitions regarding the bitmap may refer to Embodiment 2.

In some embodiments of the present disclosure, the subset of CBGs of a TB comprises a CBG(s) which is not correctly decoded in a previous transmission or a CBG(s) responded with a NACK in a CBG-based HARQ-ACK feedback.

In some embodiments of the present disclosure, the field may include a bitmap and a size of the bitmap is based on maximum number of CBGs per TB.

In an embodiment of the present disclosure, each bit of the bitmap corresponds to a CBG of a TB of the second set of TBs and indicates whether the CBG of the TB is transmitted in the transmission. For example, the second set of TBs may be ordered according to a predefined rule and the TB may be the first TB in the second set of TBs. For example, the definitions regarding the bitmap may refer to Embodiment 3.

In an embodiment of the present disclosure, each bit of the bitmap corresponds to a CBG of a single TB and indicates whether the CBG of the single TB is transmitted in the transmission in response to that the second set of TBs only includes the single TB. Alternatively, each bit of the bitmap corresponds to a number of (e.g., two) consecutive CBGs of a TB of two TBs and indicates whether the number of consecutive CBGs of the TB are transmitted in the transmission in response to that the second set of TBs only includes the two TBs. Alternatively, each bit of the bitmap corresponds to a number of (e.g., two) consecutive CBGs of a first TB or a second TB of the second set of TBs and indicates whether the number of consecutive CBGs of the first TB or the second TB is transmitted in the transmission in response to that the second set of TBs includes more than two TBs. In some examples, the second set of TBs may be ordered according to a predefined rule and the first TB and the second TB are the first and second TBs of the second set of TBs. For example, the definitions regarding the bitmap may refer to Embodiment 4.

In some embodiments, TBs in the second set of TBs are ordered according to associated HARQ process numbers, or associated DAI values, or times associated with the TBs in the second set of TBs, or indices of the serving cell on which the TBs in the second set of TBs are scheduled.

In an embodiment of the present disclosure, each bit of the bitmap corresponds to a CBG index and indicates whether a CBG(s) of TB(s) of the second set of TBs with the CBG index is transmitted in the transmission. For example, the definitions regarding the bitmap may refer to Embodiment 5.

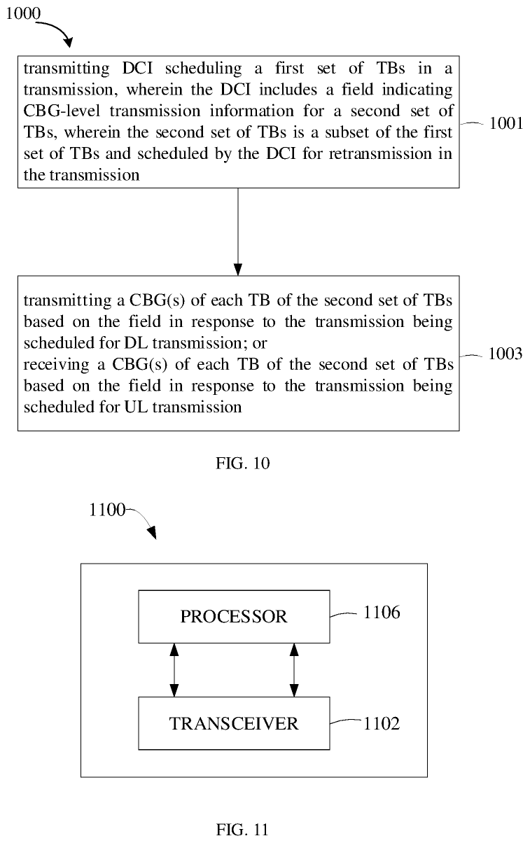

FIG. 10 is a flow chart illustrating an exemplary method for CBGTI indication in a DCI according to some embodiments of the present disclosure. The method in FIG. 10 may be implemented by a BS (e.g., BS 102 as shown in FIG. 1).

In the exemplary method shown in FIG. 10, in step 1001, the BS may transmit, to a UE (e.g., UE 101 as shown in FIG. 1), a DCI scheduling a first set of TBs in a transmission. The DCI may include a field indicating CBG-level transmission information for a second set of TBs, wherein the second set of TBs is a subset of the first set of TBs and scheduled by the DCI for retransmission in the transmission.

In step 1003, the BS may transmit, to the UE, a CBG(s) of each TB of the second set of TBs based on the field in response to the transmission being scheduled for DL transmission. For example, the specific operation in this step may refer to Embodiments 1-5.

Alternatively, in step 1003, the BS may receive, from the UE, a CBG(s) of each TB of the second set of TBs based on the field in response to the transmission being scheduled for UL transmission. For example, the specific operation in this step may refer to Embodiments 3-5.

In some embodiments of the present disclosure, the field may include a bitmap and a size of the bitmap is based on a maximum number of TBs schedulable by the DCI. For example, the definitions regarding the bitmap may refer to Embodiment 1.

In an embodiment, each bit of the bitmap corresponds to a TB of the second set of TBs and indicates whether all CBGs or only a subset of CBGs of the TB are transmitted in the transmission.

In another embodiment, each bit of the bitmap corresponds to a TB of the first set of TBs and indicates whether all CBGs or only a subset of CBGs of the TB are transmitted in the transmission.

In an embodiment, a bit of the bitmap corresponds to a TB of the first set of TBs and indicates all CBGs of the TB are transmitted in the transmission in response to at least one of the following: the transmission is an initial transmission of the TB; a plurality of CBGs of the TB is not correctly decoded in a previous transmission; the TB has a small size; the TB is scheduled by a fallback DCI format in a previous transmission; the TB is transmitted without associated scheduling DCI in a previous transmission; or none of CBGs of the TB is correctly decoded in a previous transmission.

In some embodiments of the present disclosure, the field may include an indicator indicating whether all CBGs or only a subset of CBGs of each TB of the second set of TBs are transmitted. For example, the definitions regarding the bitmap may refer to Embodiment 2.

In some embodiments of the present disclosure, the subset of CBGs of a TB comprises a CBG(s) which is not correctly decoded in a previous transmission or a CBG(s) responded with a NACK in a CBG-based HARQ-(ACK feedback.

In some embodiments of the present disclosure, the field may include a bitmap and a size of the bitmap is based on maximum number of CBGs per TB.

In an embodiment of the present disclosure, each bit of the bitmap corresponds to a CBG of a TB of the second set of TBs and indicates whether the CBG of the TB is transmitted in the transmission. For example, the second set of TBs may be ordered according to a predefined rule and the TB may be the first TB in the second set of TBs. For example, the definitions regarding the bitmap may refer to Embodiment 3.

In an embodiment of the present disclosure, each bit of the bitmap corresponds to a CBG of a single TB and indicates whether the CBG of the single TB is transmitted in the transmission in response to that the second set of TBs only includes the single TB. Alternatively, each bit of the bitmap corresponds to a number of (e.g., two) consecutive CBGs of a TB of two TBs and indicates whether the number of consecutive CBGs of the TB are transmitted in the transmission in response to that the second set of TBs only includes the two TBs. Alternatively, each bit of the bitmap corresponds to a number of (e.g., two) consecutive CBGs of a first TB or a second TB of the second set of TBs and indicates whether the number of consecutive CBGs of the first TB or the second TB is transmitted in the transmission in response to that the second set of TBs includes more than two TBs. In some examples, the second set of TBs may be ordered according to a predefined rule and the first TB and the second TB are the first and second TBs of the second set of TBs. For example, the definitions regarding the bitmap may refer to Embodiment 4.

In some embodiments, TBs in the second set of TBs are ordered according to associated HARQ process numbers, or associated DAI values, or times associated with the TBs in the second set of TBs, or indices of the serving cell on which the TBs in the second set of TBs are scheduled.

In an embodiment of the present disclosure, each bit of the bitmap corresponds to a CBG index and indicates whether a CBG(s) of TB(s) of the second set of TBs with the CBG index is transmitted in the transmission. For example, the definitions regarding the bitmap may refer to Embodiment 5.

FIG. 11 illustrates a simplified block diagram of an exemplary apparatus for CBGTI indication in DCI according to some embodiments of the present disclosure. As shown in FIG. 11, the apparatus 1100 may include at least one processor 1106 and at least one transceiver 1102 coupled to the processor 1106. The apparatus 1100 may be a UE or a BS.

Although in this figure, elements such as the at least one transceiver 1102 and processor 1106 are described in the singular, the plural is contemplated unless a limitation to the singular is explicitly stated. In some embodiments of the present disclosure, the transceiver 1102 may be divided into two devices, such as a receiving circuitry and a transmitting circuitry. In some embodiments of the present disclosure, the apparatus 1100 may further include an input device, a memory, and/or other components.

In some embodiments of the present disclosure, the apparatus 1100 may be a UE. The transceiver 1102 and the processor 1106 may interact with each other so as to perform the operations with respect to the UE described in FIGS. 1-10. In some embodiments of the present disclosure, the apparatus 1100 may be a BS. The transceiver 1102 and the processor 1106 may interact with each other so as to perform the operations with respect to the BS described in FIGS. 1-10.

In some embodiments of the present disclosure, the apparatus 1100 may further include at least one non-transitory computer-readable medium.

For example, in some embodiments of the present disclosure, the non-transitory computer-readable medium may have stored thereon computer-executable instructions to cause the processor 1106 to implement the method with respect to the UE as described above. For example, the computer-executable instructions, when executed, cause the processor 1106 interacting with transceiver 1102 to perform the operations with respect to the UE described in FIGS. 1-10.

In some embodiments of the present disclosure, the non-transitory computer-readable medium may have stored thereon computer-executable instructions to cause the processor 1106 to implement the method with respect to the BS as described above. For example, the computer-executable instructions, when executed, cause the processor 1106 interacting with transceiver 1102 to perform the operations with respect to the BS described in FIGS. 1-10.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

1. A user equipment (UE), comprising:
at least one memory; and
at least one processor coupled with the at least one memory and configured to cause the UE to:
receive downlink control information (DCI) scheduling a first set of transport blocks (TBs) in a transmission, wherein the DCI includes a field indicating code block group (CBG)-level transmission information for a second set of TBs, wherein the second set of TBs is a subset of the first set of TBs and scheduled by the DCI for retransmission in the transmission; and
receive a CBG(s) of each TB of the second set of TBs based on the field in response to the transmission being scheduled for downlink (DL) transmission; or
transmit a CBG(s) of each TB of the second set of TBs based on the field in response to the transmission being scheduled for uplink (UL) transmission.

2. The UE of claim 1, wherein the field comprises a bitmap and a size of the bitmap is based on a maximum number of TBs schedulable by the DCI.

3. The UE of claim 2, wherein each bit of the bitmap corresponds to a TB of the second set of TBs and indicates whether all CBGs or only a subset of CBGs of the TB are transmitted in the transmission.

4. The UE of claim 2, wherein each bit of the bitmap corresponds to a TB of the first set of TBs and indicates whether all CBGs or only a subset of CBGs of the TB are transmitted in the transmission.

5. The UE of claim 1, wherein the field comprises an indicator indicating whether all CBGs or only a subset of CBGs of each TB of the second set of TBs are transmitted.

6. The UE of claim 5, wherein the subset of CBGs of a TB comprises a CBG(s) which is not correctly decoded in a previous transmission or a CBG(s) responded with a negative acknowledgement (NACK) in a CBG-based hybrid automatic repeat request (HARQ)-acknowledgement (ACK) feedback.

7. The UE of claim 1, wherein the field comprises a bitmap and a size of the bitmap is based on maximum number of CBGs per TB.

8. The UE of claim 7 wherein each bit of the bitmap corresponds to a CBG of a TB of the second set of TBs and indicates whether the CBG of the TB is transmitted in the transmission.

9. The UE of claim 8, wherein the second set of TBs is ordered according to a predefined rule and the TB is the first TB in the ordered TBs.

10. The UE of claim 7, wherein
each bit of the bitmap corresponds to a CBG of a single TB and indicates whether the CBG of the single TB is transmitted in the transmission in response to that the second set of TBs only includes the single TB; or
each bit of the bitmap corresponds to a number of consecutive CBGs of a TB of two TBs and indicates whether the number of consecutive CBGs of the TB are transmitted in the transmission in response to that the second set of TBs only includes the two TBs; or
each bit of the bitmap corresponds to a number of consecutive CBGs of a first TB or a second TB of the second set of TBs and indicates whether the number of consecutive CBGs of the first TB or the second TB is transmitted in the transmission in response to that the second set of TBs includes more than two TBs.

11. The UE of claim 10, wherein TBs in the second set of TBs are ordered according to associated HARQ process numbers, or associated downlink assignment indicator (DAI) values, or times associated with the TBs in the second set of TBs, or indices of a serving cell on which the TBs in the second set of TBs are scheduled.

12. The UE of claim 7, wherein each bit of the bitmap corresponds to a CBG index and indicates whether a CBG(s) of TB(s) of the second set of TBs with the CBG index is transmitted in the transmission.

13. A base station (BS), comprising:
at least one memory; and
at least one processor coupled with the at least one memory and configured to cause the base station to:
transmit downlink control information (DCI) scheduling a first set of transport blocks (TBs) in a transmission, wherein the DCI includes a field indicating code block group (CBG)-level transmission information for a second set of TBs, wherein the second set of TBs is a subset of the first set of TBs and scheduled by the DCI for retransmission in the transmission; and
transmit a CBG(s) of each TB of the second set of TBs based on the field in response to the transmission being scheduled for downlink (DL) transmission; or
receive a CBG(s) of each TB of the second set of TBs based on the field in response to the transmission being scheduled for uplink (UL) transmission.

14. The BS of claim 13, wherein the field comprises a bitmap and a size of the bitmap is based on maximum number of CBGs per TB, and wherein each bit of the bitmap corresponds to a CBG of a TB of the second set of TBs and indicates whether the CBG of the TB is transmitted in the transmission.

15. A method performed by a user equipment (UE), the method comprising:
receiving downlink control information (DCI) scheduling a first set of transport blocks (TBs) in a transmission, wherein the DCI includes a field indicating code block group (CBG)-level transmission information for a second set of TBs, wherein the second set of TBs is a subset of the first set of TBs and scheduled by the DCI for retransmission in the transmission; and
receiving a CBG(s) of each TB of the second set of TBs based on the field in response to the transmission being scheduled for downlink (DL) transmission; or
transmitting a CBG(s) of each TB of the second set of TBs based on the field in response to the transmission being scheduled for uplink (UL) transmission.

16. A processor for wireless communication, comprising:
at least one controller coupled with at least one memory and configured to cause the processor to:
receive downlink control information (DCI) scheduling a first set of transport blocks (TBs) in a transmission, wherein the DCI includes a field indicating code block group (CBG)-level transmission information for a second set of TBs, wherein the second set of TBs is a subset of the first set of TBs and scheduled by the DCI for retransmission in the transmission; and
receive a CBG(s) of each TB of the second set of TBs based on the field in response to the transmission being scheduled for downlink (DL) transmission; or
transmit a CBG(s) of each TB of the second set of TBs based on the field in response to the transmission being scheduled for uplink (UL) transmission.

17. The processor of claim 16, wherein the field comprises a bitmap and a size of the bitmap is based on a maximum number of TBs schedulable by the DCI.

18. The processor of claim 17, wherein each bit of the bitmap corresponds to a TB of the second set of TBs and indicates whether all CBGs or only a subset of CBGs of the TB are transmitted in the transmission.

19. The processor of claim 17, wherein each bit of the bitmap corresponds to a TB of the first set of TBs and indicates whether all CBGs or only a subset of CBGs of the TB are transmitted in the transmission.

20. The processor of claim 16, wherein the field comprises an indicator indicating whether all CBGs or only a subset of CBGs of each TB of the second set of TBs are transmitted.
